(19) United States
(12) Patent Application Publication
(10) Pub. No.: US 2012/0084147 A1
(43) Pub. Date: Apr. 5, 2012

(54) METHOD AND SYSTEM FOR DETERMINING SEARCH SUGGESTIONS

(75) Inventors: Ashvin Kannan, Sunnyvale, CA (US); Christopher LuVogt, Santa Clara, CA (US); David Miller, Los Angeles, CA (US)

(73) Assignee: Yahoo! Inc., Sunnyvale, CA (US)

(21) Appl. No.: 12/897,187

(22) Filed: Oct. 4, 2010

(51) Int. Cl. G06Q 30/00; G06F 17/30

(52) U.S. Cl. 705/14.49; 707/706; 707/E17.108

(57) ABSTRACT

Disclosed is a method and system for generating search suggestions in response to receiving a search query originating from a user computing device. A server computer obtains a plurality of advanced match terms not exactly matching the search query but related to the search query, the advanced match terms previously bid on by advertisers in a bidding process. The server computer obtains advertisements associated with the advanced match terms, where each advertisement is associated with an advertiser who has won the bidding process for one of the advanced match terms. The server computer then transmits, in response to the receiving of the search query, the advanced match terms to the user computing device for display as search suggestions.

### FIELD

The present disclosure relates to search suggestions, and more specifically to a method and system for determining search suggestions based on advertiser terms.

### BACKGROUND

Web pages enabling a user to perform a web search typically include a search area where a user can input a search query to perform their web search. As the user is typing in his or her search query, many web pages display search suggestions below the search area to aid the user in his or her searching. These search suggestions are often retrieved from log files containing information about previously performed searches and/or search result metadata relating to previously identified search results (data about the search results). Search suggestions may also be displayed after the user has searched, or in places outside of the search environment.

### SUMMARY

This disclosure relates to a method and system for generating search suggestions in response to receiving a search query originating from a user computing device. In one aspect, a server computer obtains a plurality of advanced match terms not exactly matching the search query but related to the search query, the advanced match terms previously bid on by advertisers in a bidding process. The server computer obtains advertisements associated with the advanced match terms, where each advertisement is associated with an advertiser who has won the bidding process for one of the advanced match terms. The server computer then transmits, in response to the receiving of the search query, the advanced match terms to the user computing device for display as search suggestions.

In one embodiment, the server computer also transmits the advertisements associated with the advanced match terms to the user computing device for display. In one embodiment, the server computer obtains the advanced match terms from an advertisement server computer.

In one embodiment, the server computer obtains an exact match term exactly matching the search query, the exact match term previously bid on by advertisers in a bidding process. The server computer obtains advertisements associated with the exact match term, where each advertisement is associated with an advertiser who has won the bidding process for the exact match term. The server computer transmits, in response to the receiving of the search query, the exact match term (and/or the advertisement associated with the exact match term) to the user computing device for display as a search suggestion (or as an advertisement).

In one embodiment, the obtaining of the advanced match terms further includes building a suggestion graph comprising the advanced match terms. A weight can be assigned to each suggestion edge in the suggestion graph. In one embodiment, the advanced match terms are ranked using the weight of each suggestion edge in the suggestion graph. In one embodiment, direct links and reverse links are added in the suggestion graph. In one embodiment, a term that is part of the advanced match terms is determined by determining a threshold weight based on the weight assigned to its suggestion edge. In one embodiment, the weight assigned to each suggestion edge in the suggestion graph further includes computing an edge weight using the formula:

$$tanh ( 2 \frac{{\sum }_{i} Wi \cdot Fi}{{\sum }_{i} Wi} )$$

where Wi are weights and Fi are features likely to indicate a good suggestion.

These and other aspects and embodiments will be apparent to those of ordinary skill in the art by reference to the following detailed description and the accompanying drawings.

### BRIEF DESCRIPTION OF THE DRAWINGS

In the drawing figures, which are not to scale, and where like reference numerals indicate like elements throughout the several views:

FIG. 1 is a block diagram of a user computing device communicating with a server computer over a network in accordance with an embodiment of the present disclosure;

FIG. 2A is a flowchart illustrating steps performed in accordance with an embodiment of the present disclosure;

FIG. 2B is another flowchart illustrating steps performed in accordance with an embodiment of the present disclosure;

FIG. 3 is an example of a display screen of search results and search suggestions displayed in response to a search query submitted to the server computer of FIG. 1 in accordance with an embodiment of the present disclosure;

FIG. 4 is a block diagram of a suggestion graph generated by the server computer of FIG. 1 after receiving the search query of FIG. 3 in accordance with an embodiment of the present disclosure;

FIG. 5 is a block diagram of an expanded suggestion graph in accordance with an embodiment of the present disclosure;

FIG. 6 is block diagram of a suggestion graph with edge weights to generate search suggestions in response to receiving the search query of FIG. 3 in accordance with an embodiment of the present disclosure; and

FIG. 7 is a block diagram illustrating an internal architecture of a computing device in accordance with an embodiment of the present disclosure.

### DESCRIPTION OF EMBODIMENTS

Embodiments are now discussed in more detail referring to the drawings that accompany the present application. In the accompanying drawings, like and/or corresponding elements are referred to by like reference numbers.

Various embodiments are disclosed herein; however, it is to be understood that the disclosed embodiments are merely illustrative of the disclosure that can be embodied in various forms. In addition, each of the examples given in connection with the various embodiments is intended to be illustrative, and not restrictive. Further, the figures are not necessarily to scale, some features may be exaggerated to show details of particular components (and any size, material and similar details shown in the figures are intended to be illustrative and not restrictive). Therefore, specific structural and functional details disclosed herein are not to be interpreted as limiting, but merely as a representative basis for teaching one skilled in the art to variously employ the disclosed embodiments.

The present invention is described below with reference to block diagrams and operational illustrations of methods and devices to select and present media related to a specific topic. It is understood that each block of the block diagrams or operational illustrations, and combinations of blocks in the block diagrams or operational illustrations, can be implemented by means of analog or digital hardware and computer program instructions. These computer program instructions can be provided to a processor of a general purpose computer, special purpose computer, ASIC, or other programmable data processing apparatus, such that the instructions, which execute via the processor of the computer or other programmable data processing apparatus, implements the functions/acts specified in the block diagrams or operational block or blocks.

In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved. Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

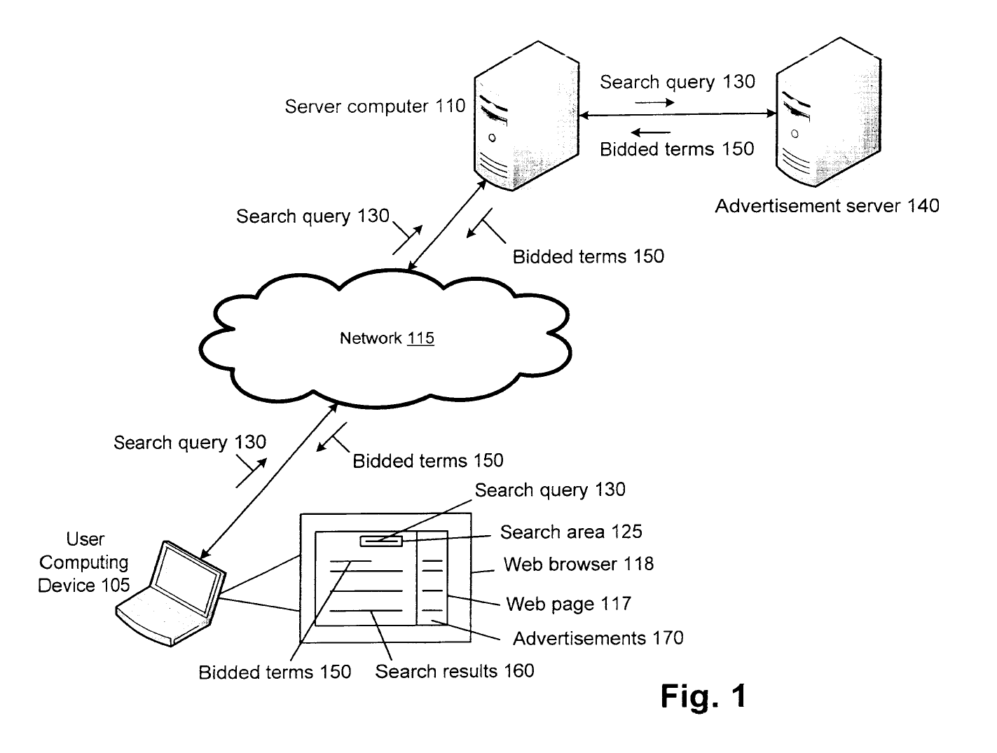

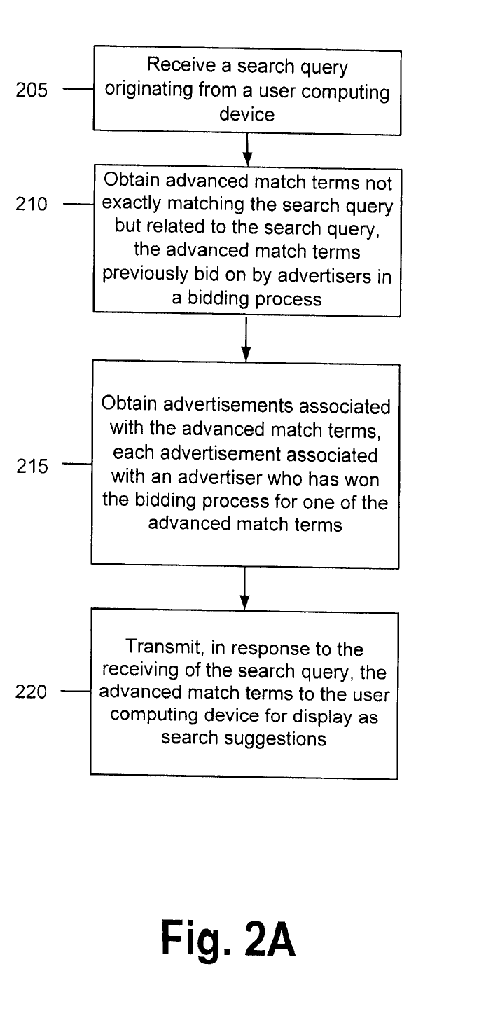

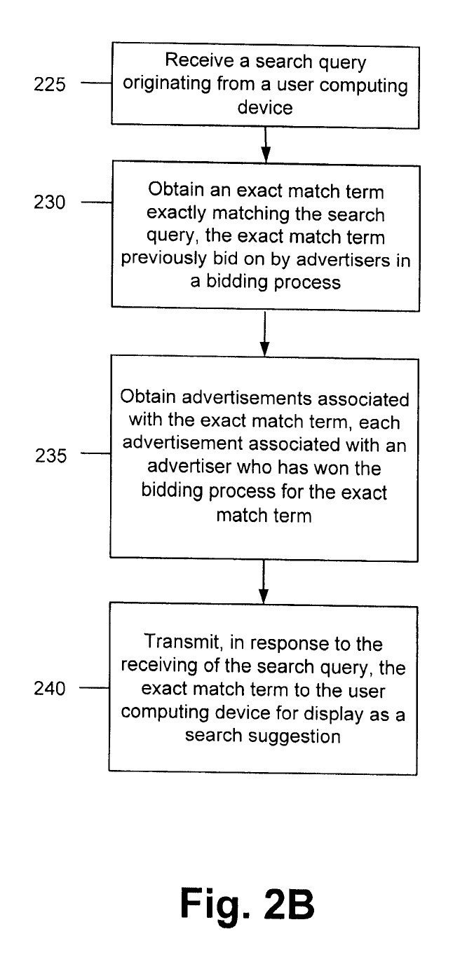

FIG. 1 is a block diagram of an embodiment of a user computing device 105 communicating with a server computer 110 over a network 115 such as the Internet. FIG. 2A is a flowchart illustrating an embodiment of the steps performed to generate search suggestions. The server computer 110 serves a web page 117 to the user computing device 105 in response to a request by the user computing device 105 for the web page 117. The user computing device 105 uses a web browser 118 to display the web page 117. As is known in the art, web pages, electronic documents, and web browsers may contain an area or portion within which text may be input and/or other actions may be performed.

For the purposes of this disclosure the term “server” should be understood to refer to a service point which provides processing, database, and communication facilities. By way of example, and not limitation, the term “server” can refer to a single, physical processor with associated communications and data storage and database facilities, or it can refer to a networked or clustered complex of processors and associated network and storage devices, as well as operating software and one or more database systems and applications software which support the services provided by the server.

In one embodiment, the web page 117 includes a search area 125 displayed by the user interface (web page) which enables the user to input a search query 130 into the search area 125 and perform a web search for the search query 130. The web browser 118 transmits the search query 130 to the server computer 110 over the network 115 and the server computer 110 receives the search query 130 (Step 205).

Search advertising is sold and delivered on the basis of search queries. The user of a search engine (e.g., web page 117) inputs search query 130 to make queries. Search query 130 may consist of one or more characters. Search engines conduct running auctions to sell advertisements according to bids received for search queries and relative relevance of user search queries to advertisements in an inventory. For example, the search query “home mortgage refinancing” is usually more expensive than one that is in less demand, such as “used bicycle tires.”

In the bid-based model, the advertiser signs a contract that allows them to compete against other advertisers in a private auction hosted by advertisement server 140 (or server computer 110). Each advertiser informs the advertisement server 140 of the maximum amount that he or she is willing to pay for a given advertisement spot (often based on a search query). The auction plays out in an automated fashion every time a visitor triggers the advertisement spot.

When the advertisement spot is part of a search engine results page (SERP), the automated auction takes place whenever a search for the search query 130 that is being bid upon occurs. In one embodiment, bids for the search query 130 that target the searcher's geo-location, the day and time of the search, etc. are compared and the winner is then determined. In situations where there are multiple advertisement spots, a common occurrence on SERPs, there can be multiple winners whose positions on the page are influenced by the amount each has bid. The advertisement with the highest bid generally shows up first, though additional factors such as advertisement quality and relevance may also affect the location of the advertisement.

In one embodiment, the server computer 110 obtains a plurality of advanced match terms that do not exactly match the search query 130 but are related to the search query 130, the advanced match terms previously bid on by advertisers in the bidding process (Step 210). In one embodiment, the server computer 110 (or advertisement server 140) obtains advertisements associated with the advanced match terms, where each advertisement is associated with an advertiser who has won the bidding process for one of the advanced match terms (Step 215). The server computer 110 transmits these advanced match terms 150 to the user computing device 105 for display as search suggestions (Step 220). Although different steps are being performed by the server computer 110 and the advertisement server 140, it should be noted that any one or more of the steps can be performed by either of the server computer 110 and the advertisement server 140, or the function can be combined in a single server.

In one embodiment, the server computer 110 transmits the advertisements associated with the plurality of advanced match terms to the user computing device 105 for display. In one embodiment, these advertisements are received from the advertisement server 140.

In one embodiment and referring to FIG. 2B, the server computer 110 receives a search query 130 (Step 225) and can obtain an exact match term exactly matching the search query, where the exact match term was previously bid on by advertisers in the bidding process (Step 230). The server computer 110 obtains advertisements associated with the exact match term, where each advertisement is associated with an advertiser who has won the bidding process for the exact match term (Step 235). The server computer 110 can then transmit the exact match term to the user computing device 105 for display as a search suggestion (Step 240). In one embodiment, the advertisements associated with the exact match term are transmitted to the user computing device 105 for display.

In one embodiment, the bidded terms 150 are displayed after the user types the search query 130 into the search area 125. In one embodiment, the bidded terms 150 are displayed as part of the search results 160 (e.g., the first line of the search results 160). In another embodiment, the web page 117 is divided into two areas after a search is performed—a first area containing search results 160 and a second area containing advertisements 170. The search results and/or advertisements may be text-based advertisements, video, audio, and/or graphical (e.g., photographs or pictures). The bidded terms 150 can be displayed as part of the search results 160 and/or the advertisements 170.

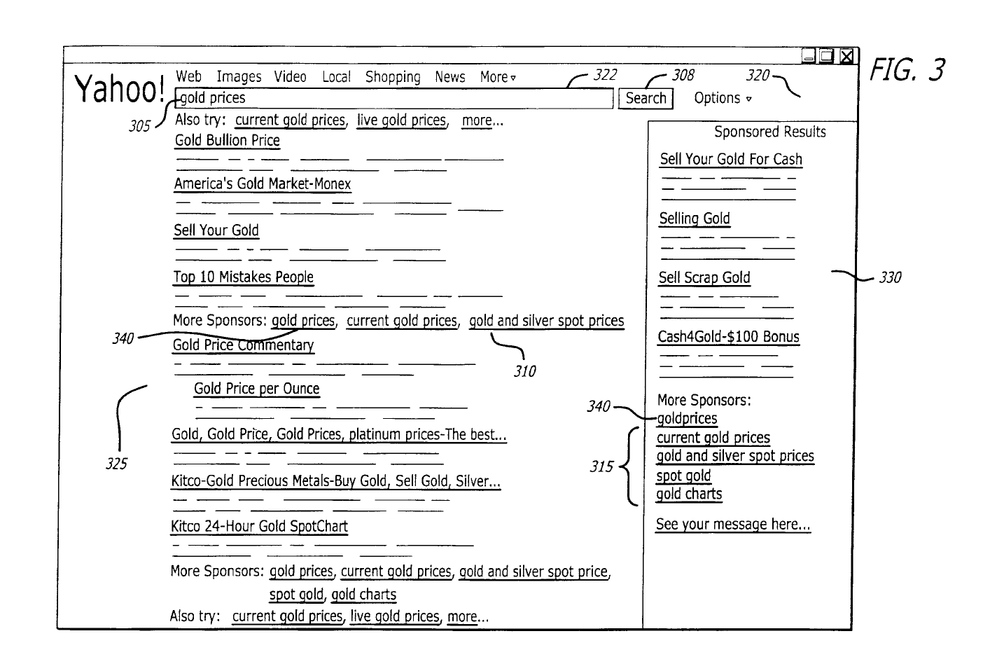

For example and referring to FIG. 3, suppose a user types in a search query “gold prices” 305 and enters the search query 305 (e.g., presses the Enter key or uses the user's mouse to click on a Search button 308). In one embodiment, the server computer 110 determines advanced match terms that don't exactly match the search query “gold prices” and that have been bidded on by advertisers. These bidded terms are displayed in one or more locations 310, 315 on web page 320. FIG. 3 shows these terms as being “current gold prices” and “gold and silver spot prices” shown in search results section 325 and “current gold prices”, “gold and silver spot prices”, “spot gold”, and “gold charts” in advertisements section 330. It should be noted that the search suggestions (bidded terms) can be displayed in any one or more locations on the web page 320 after the search query 305 is received or while the search query 305 is being typed into the search area 322 (e.g., below the search area 322).

In one embodiment, if the user clicks on one of these bidded terms, the user is directed to a web page that contains advertisements related to the selected bidded term. FIG. 3 also shows “gold prices” as a search result—this is a bidded term that is an exact match 340 to the search query. The exact match bidded term 340 may or may not be included in the search results section 325 and/or the advertisements section 330.

For a given search query, the process described herein can be performed either dynamically (online) during serve time, or statically (offline) by analyzing past serving logs and/or polling the advertisement server 140. The set of bidded terms are then considered and filters are used to select high-quality terms that are likely to make good suggestions (e.g., by counting the number of ads with a given bidded term, looking at the specific advanced match technology used, placing limits on confidence and clickability and other scores provided by underlying advanced match technologies to indicate quality and/or relevance, eliminating terms that use certain “empty” words, reversing the mapping of a query-bidded term, etc.).

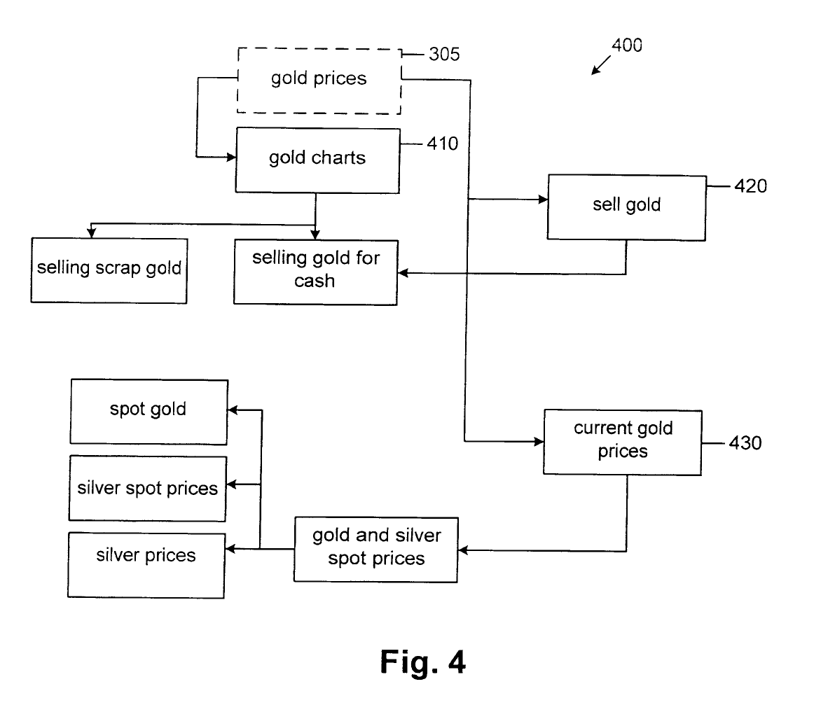

In one embodiment, the server computer 110 generates a suggestion graph consisting of disjoint subgraphs. FIG. 4 illustrates an example of a suggestion graph 400 in light of the search query “gold prices” 305 (shown as a dashed box in FIG. 4). Nodes of the suggestion graph 400 are strings (queries and bidded terms), and directed edges represent possible suggestion relationships. Additional edges are added in the graph by partially completing each subgraph: reverse edges are added (if A→B, then B→A) whenever possible, as are direct links from grandparents to grandchildren (if A→B and B→C, then add A→C). In one embodiment, each edge is then assigned a weight based on a number of features, and for each node, a list of suggestions is generated by sorting and thresholding its cohorts (same subgraph) according to its weight.

The suggestion graph 400 includes the advanced match nodes (shown as solid boxes in FIG. 4) to the search query “gold prices” 305. For example, the suggestion graph 400 includes advanced match nodes “gold charts” 410, “sell gold” 420, and “current gold prices” 430. In one embodiment, a node in the suggestion graph has the following attributes: query/suggestion string; frequency (number of times this query has been issued over a given period of time); estimated revenue; estimated Sponsored Search ad depth (number of ads typically shown for this query); suggestion flag (true if query can also be used as a suggestion); #inlinks and #outlinks (edges that point towards or away from this node, respectively, in the suggestion graph); and a unique subgraph identifier.

Each node is connected by an edge of the graph 400. An edge in the graph 400 has the following attributes: “from” and “to” nodes (“A” and “B”); average clickability of ads which have bidded term B when shown for query A; average number of ads which have bidded term B when shown for query A; and “distance” which roughly represents how far away B is from A in the original graph 400, before subgraphs have been partially completed. In one embodiment, limits are placed on the number of inlinks, outlinks, and subgraph size (e.g., each of these are capped at 50).

In one embodiment, the “clean” version of a query is one which has been lowercased, spell-corrected, and special characters have been removed or replaced with spaces. A query is considered a “valid suggestion” if it does not have a spell correction, does not contain any term from a predetermined list, does not contain predetermined terms (e.g., cheap, free, easy, best, new, buy, for sale), does not end in a predetermined ending (e.g., .com, .edu, .biz, .net, .org, and/or .info), is of length a given length (e.g., >=4 and <=35), and does not contain any non-ASCII characters or predetermined special characters (e.g., %, $, /, _, :, *, (,), =, {,}, [,], <, >, ;, \, and/or |).

In one embodiment, for each query Q in top N=5 million terms for the previous month, the server computer 110 scrapes the advertisement server 140 to retrieve relevant ads. In one embodiment, for each unique bidded term B on advanced matched ads, an edge is added in the graph from Q→B (if B is valid) and an edge (Q→clean(B) (if valid) is added, and from B→Q (if Q is valid), using clickability, ad depth, and RPS information from the scrape.

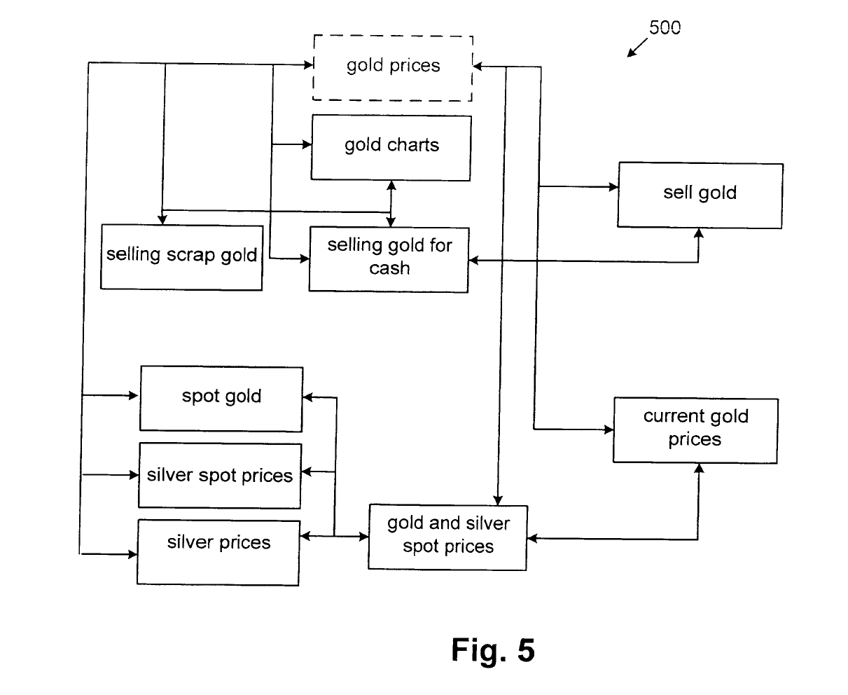

In one embodiment, once the suggestion graph 400 is generated, the server computer expands the suggestion graph by adding backlinks and grandchildren. FIG. 5 shows an example of an expanded suggestion graph 500.

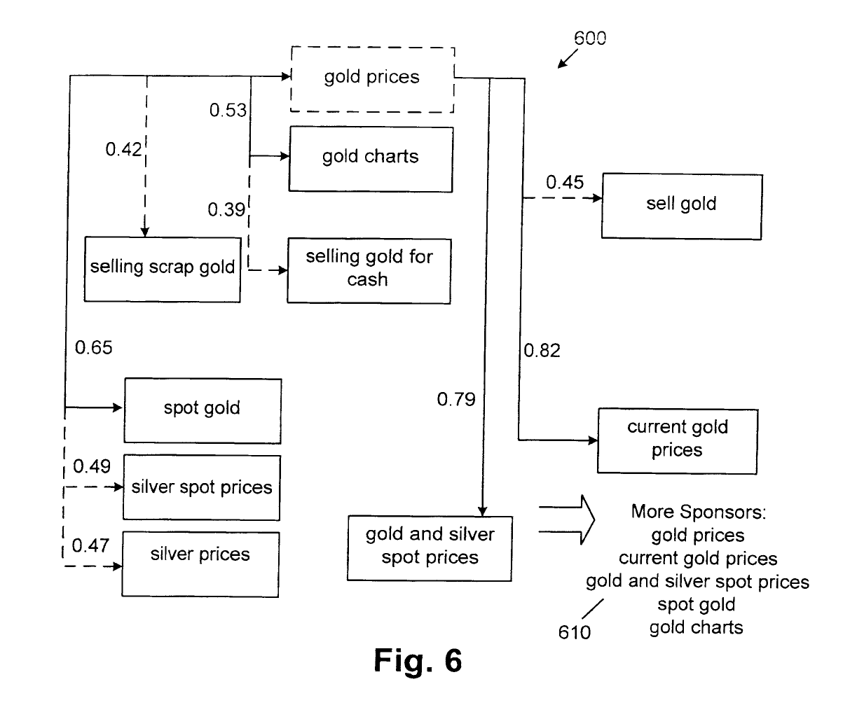

The server computer 110 then assigns edge weights to the suggestion graph. FIG. 6 shows an embodiment of a suggestion graph 600 with edge weights added to various edges. These edge weights are determined as follows:

For each node A in the graph; for each suggestion candidate B in the same subgraph as A:
Compute an edge weight:

$$tanh ( 2 \frac{{\sum }_{i} Wi \cdot Fi}{{\sum }_{i} Wi} )$$

where Wi are weights (e.g., chosen to get reasonable precision/recall trade-off). In one embodiment, these weights are hand-tuned. In one embodiment, these weights are determined using machine learning techniques.
and Fi are features likely to indicate a good suggestion (as described below)
If the edge weight is greater than a predetermined threshold weight (e.g., 0.5), include B as a suggestion for A
   In one embodiment, the server computer 110 sorts the suggestions by a multiplicative combination of RPS and Depth. The edges are different in FIG. 6 relative to FIG. 5 or FIG. 4 because FIG. 6 is focusing on determining the suggestions for the single term “gold prices”, whereas FIGS. 4 and 5 are examples of an entire subgraph, and could be used to determine the suggestions for any of the terms represented by nodes in the graphs.

In one embodiment, nine features Fi are used, and each is a real number from 0 to 1. The primary dimensions these features rely on are: DirectNeighbor(A,B) (a binary feature indicating whether or not B is a bidded term for some advertisement shown for query A), GraphDistance(A,B) (the shortest number of edges connecting A to B), TokenSimilarity(A,B) (as described below), |Freq(A)−Freq(B)| (the absolute difference in the frequencies of A and B as queries), Clickability of ads with bidterm B shown on query A (where clickability is a position-independent estimate of the click rate of an ad), Depth (mean number) of ads with bidterm B shown on query A, RPS(B) (historical revenue per search for term B), and Depth(B) (historical number of ads shown for term B). In one embodiment, edges are considered possible suggestions, with the following exemplary exceptions: 1) the original query is scanned to see if it contains any terms on a predetermined trademark phrase list—the shortest length such trademark phrase must also be present in all suggestions for that query; 2) suggestions which are edit-distance 1 away from the query are not considered (suggestion should not be too similar to query, esp. plurals); and 3) suggestions which are edit-distance 1 or 2 away from some other suggestion for the same query are not considered.

In one embodiment, the following formula is used to assign edge weights, rank, and filter the bidded terms:
2*DirectNeighbor (A,B)+
7 *1/GraphDistance (A,B)+
5*(1−|0.6−TokenSimilarity (A,B)|†)+
2*(1−|0.6−FuzzyTokenSimilarity (A,B)†|)+
5*|Freq (A)−Freq (B)|̂ (−0.25)+
7*tan h (CLKB (B|A)/5)+
5*tan h (Depth (B|A)/5)+
2*tan h (RPS(B)/2)+
2*tan h (Depth (B)/10)

†TokenSimilarity(A,B)=mean ratio of number of common tokens to number of tokens*[Overlap(A,B)/Tokens(A)+Overlap(A,B)/Tokens(B)]/2

†FuzzyTokenSimilarity (A,B)=same as above, except tokens are “same” if edit distance is 1 or 0 (captures plurals)

As shown in FIG. 6, the edge weights shown results in the displayed list of advanced matches 610 (current gold prices, gold and silver spot prices, spot gold, and gold charts) being generated and displayed as search suggestions when a search query of “gold prices” is entered. These advanced matches 610 have edge weights that are above 0.5. This threshold amount of 0.5 is exemplary and can be set to any weight cutoff value.

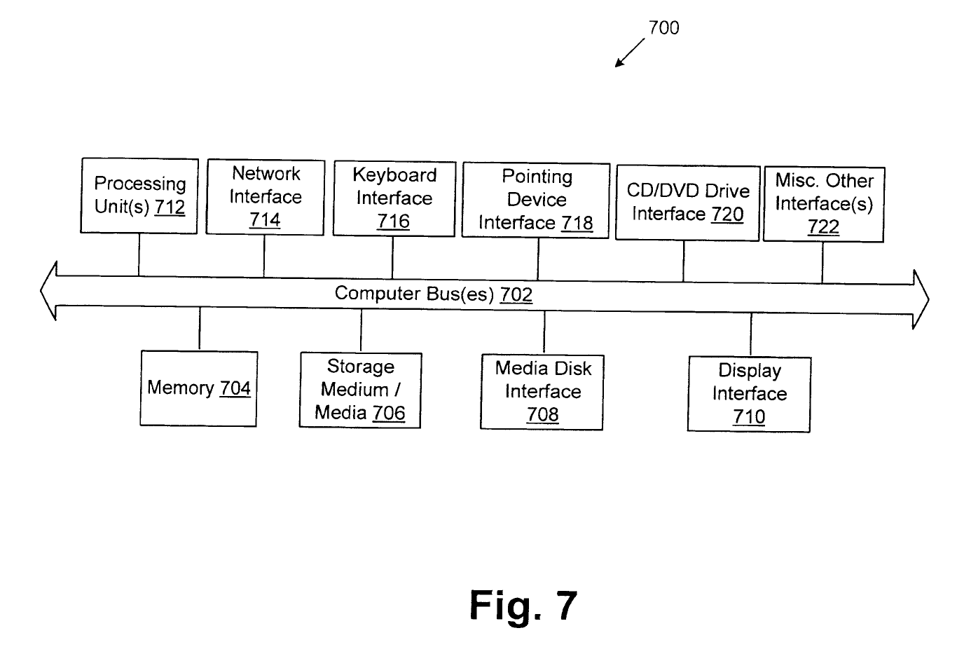

FIG. 7 is a block diagram illustrating an internal architecture of an example of a computing device, such as server computer 110 and/or user computing device 105, in accordance with one or more embodiments of the present disclosure. A computing device as referred to herein refers to any device with a processor capable of executing logic or coded instructions, and could be a server, personal computer, set top box, smart phone, pad computer or media device, to name a few such devices. As shown in the example of FIG. 7, internal architecture 700 includes one or more processing units (also referred to herein as CPUs) 712, which interface with at least one computer bus 702. Also interfacing with computer bus 702 are persistent storage medium/media 706, network interface 714, memory 704, e.g., random access memory (RAM), run-time transient memory, read only memory (ROM), etc., media disk drive interface 708 as an interface for a drive that can read and/or write to media including removable media such as floppy, CD-ROM, DVD, etc. media, display interface 710 as interface for a monitor or other display device, keyboard interface 716 as interface for a keyboard, pointing device interface 718 as an interface for a mouse or other pointing device, and miscellaneous other interfaces not shown individually, such as parallel and serial port interfaces, a universal serial bus (USB) interface, and the like.

Memory 704 interfaces with computer bus 702 so as to provide information stored in memory 704 to CPU 712 during execution of software programs such as an operating system, application programs, device drivers, and software modules that comprise program code, and/or computer-executable process steps, incorporating functionality described herein, e.g., one or more of process flows described herein. CPU 712 first loads computer-executable process steps from storage, e.g., memory 704, storage medium/media 706, removable media drive, and/or other storage device. CPU 712 can then execute the stored process steps in order to execute the loaded computer-executable process steps. Stored data, e.g., data stored by a storage device, can be accessed by CPU 712 during the execution of computer-executable process steps.

Persistent storage medium/media 706 is a computer readable storage medium(s) that can be used to store software and data, e.g., an operating system and one or more application programs. Persistent storage medium/media 706 can also be used to store device drivers, such as one or more of a digital camera driver, monitor driver, printer driver, scanner driver, or other device drivers, web pages, content files, playlists and other files. Persistent storage medium/media 706 can further include program modules and data files used to implement one or more embodiments of the present disclosure.

For the purposes of this disclosure a computer readable medium stores computer data, which data can include computer program code that is executable by a computer, in machine readable form. By way of example, and not limitation, a computer readable medium may comprise computer readable storage media, for tangible or fixed storage of data, or communication media for transient interpretation of code-containing signals. Computer readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer readable storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client or server or both. In this regard, any number of the features of the different embodiments described herein may be combined into single or multiple embodiments, and alternate embodiments having fewer than, or more than, all of the features described herein are possible. Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

While the system and method have been described in terms of one or more embodiments, it is to be understood that the disclosure need not be limited to the disclosed embodiments. It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A method comprising:
receiving, by a server computer, a search query originating from a user computing device;
obtaining, by the server computer, a plurality of advanced match terms not exactly matching the search query but related to the search query, the plurality of advanced match terms previously bid on by advertisers in a bidding process;
obtaining, by the server computer, advertisements associated with the plurality of advanced match terms, each advertisement associated with an advertiser who has won the bidding process for one of the plurality of advanced match terms; and
transmitting, by the server computer and in response to the receiving of the search query, the plurality of advanced match terms to the user computing device for display as search suggestions.

2. The method of claim 1, further comprising transmitting, by the server computer and in response to the receiving of the search query, the advertisements associated with the plurality of advanced match terms to the user computing device for display.

3. The method of claim 1 wherein the obtaining of the plurality of advanced match terms further comprises receiving the plurality of advanced match terms from an advertisement server computer.

4. The method of claim 1 further comprising:
obtaining, by the server computer, an exact match term exactly matching the search query, the exact match term previously bid on by advertisers in a bidding process;
obtaining, by the server computer, advertisements associated with the exact match term, each advertisement associated with an advertiser who has won the bidding process for the exact match term; and
transmitting, by the server computer and in response to the receiving of the search query, the exact match term to the user computing device for display as a search suggestion.

5. The method of claim 4, further comprising transmitting, by the server computer and in response to the receiving of the search query, the advertisement associated with the exact match term to the user computing device for display.

6. The method of claim 1 wherein the obtaining of the plurality of advanced match terms further comprises building a suggestion graph comprising the plurality of advanced match terms.

7. The method of claim 6 further comprising assigning a weight to each suggestion edge in the suggestion graph.

8. The method of claim 7 further comprising ranking the plurality of advanced match terms using the weight of each suggestion edge in the suggestion graph.

9. The method of claim 6 further comprising adding direct links and reverse links in the suggestion graph.

10. The method of claim 8 further comprising determining that a term is part of the plurality of advanced match terms by determining a threshold weight based on the weight assigned to its suggestion edge.

11. The method of claim 7 wherein the weight assigned to each suggestion edge in the suggestion graph further comprises computing an edge weight using the formula:
$$tanh ( 2 \frac{{\sum }_{i} Wi \cdot Fi}{{\sum }_{i} Wi} )$$
where Wi are weights and Fi are features likely to indicate a good suggestion.

12. The method of claim 1 further comprising transmitting search results to the user computing device when the user selects the bidded term.

13. A computer readable storage medium tangibly storing thereon computer program instructions capable of being executed by a computer processor, the computer program instructions defining the steps of:
receiving a search query originating from a user computing device;
obtaining a plurality of advanced match terms not exactly matching the search query but related to the search query, the plurality of advanced match terms previously bid on by advertisers in a bidding process;
obtaining advertisements associated with the plurality of advanced match terms, each advertisement associated with an advertiser who has won the bidding process for one of the plurality of advanced match terms; and
transmitting, in response to the receiving of the search query, the plurality of advanced match terms to the user computing device for display as search suggestions.

14. The computer readable storage medium of claim 13, further comprising transmitting, in response to the receiving of the search query, the advertisements associated with the plurality of advanced match terms to the user computing device for display.

15. The computer readable storage medium of claim 13, wherein the obtaining of the plurality of advanced match terms further comprises receiving the plurality of advanced match terms from an advertisement server computer.

16. The computer readable storage medium of claim 13 further comprising:
obtaining an exact match term exactly matching the search query, the exact match term previously bid on by advertisers in a bidding process;
obtaining advertisement associated with the exact match term, each advertisement associated with an advertiser who has won the bidding process for the exact match term; and
transmitting, in response to the receiving of the search query, the exact match term to the user computing device for display as a search suggestion.

17. The computer readable storage medium of claim 16, further comprising transmitting, in response to the receiving of the search query, the advertisement associated with the exact match term to the user computing device for display.

18. The computer readable storage medium of claim 13 wherein the obtaining of the plurality of advanced match terms further comprises building a suggestion graph comprising the plurality of advanced match terms.

19. The computer readable storage medium of claim 18 further comprising assigning a weight to each suggestion edge in the suggestion graph.

20. The computer readable storage medium of claim 19 further comprising ranking the plurality of advanced match terms using the weight of each suggestion edge in the suggestion graph.

21. The computer readable storage medium of claim 18 further comprising adding direct links and reverse links in the suggestion graph.

22. The computer readable storage medium of claim 20 further comprising determining that a term is part of the plurality of advanced match terms by determining a threshold weight based on the weight assigned to its suggestion edge.

23. The computer readable storage medium of claim 19 wherein the weight assigned to each suggestion edge in the suggestion graph further comprises computing an edge weight using the formula:
$$tanh ( 2 \frac{{\sum }_{i} Wi \cdot Fi}{{\sum }_{i} Wi} )$$
where Wi are weights and Fi are features likely to indicate a good suggestion.

24. The computer readable storage medium of claim 13 further comprising transmitting search results to the user computing device when the user selects the bidded term.

25. A server computer comprising:
a data storage; and
a processor for
receiving a search query originating from a user computing device;
obtaining a plurality of advanced match terms not exactly matching the search query but related to the search query, the plurality of advanced match terms previously bid on by advertisers in a bidding process;
obtaining advertisements associated with the plurality of advanced match terms, each advertisement associated with an advertiser who has won the bidding process for one of the plurality of advanced match terms; and
transmitting, in response to the receiving of the search query, the plurality of advanced match terms to the user computing device for display as search suggestions.
